(19) United States
(12) Patent Application Publication
(10) Pub. No.: US 2004/0243371 A1
(43) Pub. Date: Dec. 2, 2004

(54) System and method for automatic derivation of coverage metrics for validation of pipelined designs

(75) Inventors: Boris S. Gutkovich, Haifa (IL); Daniel Even-Haim, Kiryat-Tivon (IL); Moshe Sananes, Haifa (IL)

Correspondence Address: FLESHNER & KIM, LLP, P.O. BOX 221200, CHANTILLY, VA, 20153, US

(73) Assignee: INTEL CORPORATION

(21) Appl. No.: 10/448,425

(22) Filed: May 30, 2003

(51) Int. Cl. G06F 17/50

(52) U.S. Cl. 703/14

(57) ABSTRACT

A functional verification method and method that uses automatic extraction of coverage metrics to verify pipeline designs in a simulation-based validation flow. The method can target data transfer features of pipelined designs. Several of the metrics used are a one stage transfer metric (OST), a path metric, a one stage sequence (OSS) metric, a microinstruction flow (MIF) metric, and a microinstruction sequence (MIS) metric.

### BACKGROUND OF THE INVENTION

1. Field of the Invention

The present invention is directed towards functional coverage metrics used in a functional verification process, and more particularly to a system and method for deriving functional coverage metrics from a Register Transfer Level (RTL) design description.

2. Background of the Related Art

As circuit complexity grows with increases in technological innovation, there is a growing need for tools that functionally verify designs so that any design problems or faults residing in a design may be identified and corrected prior to shipping the product to the end user and other customers. In the related art there are different coverage metrics that are used to verify hardware in the simulation-based, coverage-driven validation flow.

The majority of existing coverage metrics can be divided into two groups: structural and functional. The most popular structural metrics are RTL code coverage metrics (e.g. statement, branch, condition, path, and toggle) and Finite State Machine (FSM) coverage metrics (e.g. state, arc, and path). Functional coverage metrics are ad-hoc metrics defined by verification engineers. In the related art, an automatic derivation is implemented for the code and the FSM coverage metrics. These metrics do not take into consideration specific features of pipelined designs. Because of these inherent characteristics, they are not very effective in driving validation towards finding difficult-to-catch bugs.

The exemplary embodiments of the present invention are used to automatically extract and abstract data paths of a pipeline as a formal model for building functional coverage metrics that are used in the validation of the pipeline control. This enables the extraction of pipeline data path and control from a circuit that has both pipelined and non-pipelined blocks. The claimed invention can also be adapted and applied to non-pipelined designs.

### BRIEF DESCRIPTION OF THE DRAWINGS

The invention will be described in detail with reference to the following drawings in which like reference numerals refer to like elements wherein:

FIG. 1 illustrates an exemplary representation of a PipeCover flow;

FIG. 2 provides an example illustrating how PipeCover creates a pipeline graph from the RTL model;

FIG. 3 provides an example illustrating how a coverage metric “Micro Instruction Flow” is defined;

FIG. 4 illustrates an exemplary method and application of a PipeCover in a Functional Coverage Validation System; and

FIG. 5 illustrates an exemplary system incorporating one embodiment of the present invention.

### DETAILED DESCRIPTION OF PREFERRED EMBODIMENTS

Functional verification refers to the process of ensuring that a device under verification and test complies with a desired product specification, and more specifically to the RTL description. In this context, functional coverage provides a feedback mechanism to identify the areas of functionality (e.g. features, corner cases and complex interactions between different components) that have been exercised and covered and those areas of functionality that still need to be tested. Coverage metric indicators provide a measure of the validation quality, and an indirect measure of the design quality. Different functional coverage metrics are oriented on data transfer properties of various pipelines. Coverage metrics and their methods of derivation from RTL design description will now be discussed.

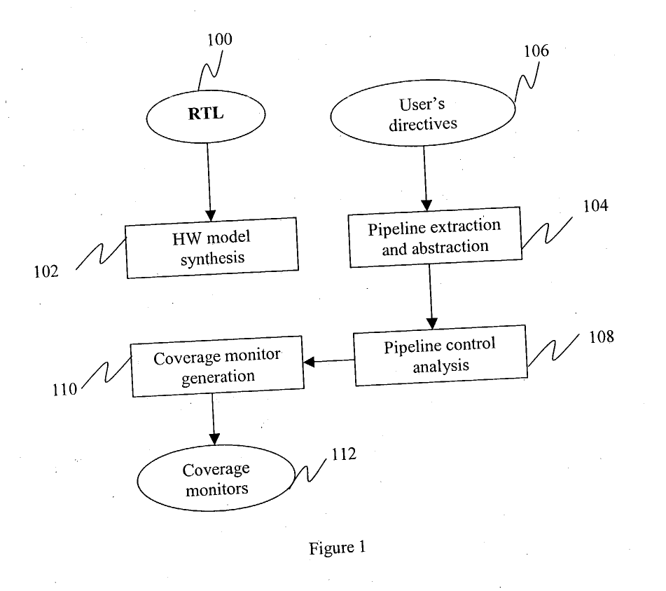

FIG. 1 illustrates an exemplary representation of a PipeCover flow. The term PipeCover is used to describe the method described herein and the tools that support the method. A starting point of the PipeCover flow is a synthesizable RTL model 100 of a design under test (DUT). Initially, the hardware model of the DUT is constructed by the process of hardware inference 102.

Another task in the PipeCover flow involves identifying a pipeline structure by abstraction 104. This task separates the data path and control flow and abstracts away any unneeded logic. A set of user's directives 106 is input into the pipeline extraction and abstraction step 104 to assist in implementing the user's verification objectives.

Pipeline control and analysis is performed in 108. For example, for each pipeline stage in a circuit, logic conditions are calculated when the pipeline registers are open or closed for the particular data sources. This information is used to form a pipeline graph, which represents connections of the pipeline registers and logic conditions of data transfer via the pipe. Upon demand, a graphical representation of the pipeline graph is shown to the user for making the graph pruning and defining user-specific coverage metrics.

A set of predefined coverage metrics is used as shortcuts for automatic generation 110 of coverage monitors 112 as shown in FIG. 1.

In one exemplary embodiment, a synthesizable RTL model is used as input 100 for extraction of coverage metrics. A synthesizable model refers to an RTL description that can be automatically transformed to lower (logic) level of the design representation. This transformation process is called logic synthesis.

In logical synthesis, inference of hardware elements (e.g. registers, adders, random logic, etc.) is obtained from the RTL statements. In order to improve performance, fast logic synthesis is used without logic optimization. Those skilled in the art will appreciate that logical synthesis is a commonly used front-end process used in different verification tools such as Formal Equivalence and Formal Property verification and other types of logical synthesis may be used without departing from the spirit and scope of the present invention.

In the pipeline extraction and abstraction step 104 shown in FIG. 1, the following functions are performed. The data path and control logic are separated. In the data path, data processing and data transfer logic is recognized. Then, the data processing logic and its control is abstracted away. Parts of the data path that have the same control are identified and recognized.

As a result of the pipeline extraction and abstraction process, a simplified hardware model is obtained. For example, a datapath may contain one-bit latches, data-transfer blocks and OR gates that replace data processing logic. The control part of the model contains logic that is in the fan in cones of the abstract datapath inputs. The structure of the pipeline graph is derived from the abstract data path by replacing all of the combinatorial elements with the logic conditions {Cᵢ}, attached to the graph arcs.

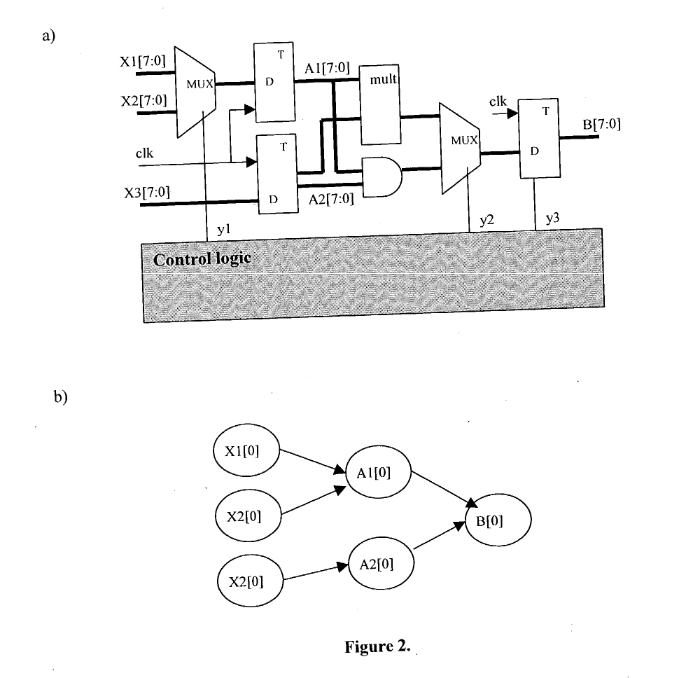

An exemplary RTL model and a pipeline graph are shown in FIG. 2. FIG. 2 also shows how the graph is related to RTL. The RTL model illustrated in FIG. 2a contains a data path logic (shown in details) and a control logic, shown as a black-box. The data path contains: three 8-bit registers (A1[7:0], A2[7:0], B[7:0]), data processing logic that performs arithmetic multiplication or bit-wise logic multiplication on values in the registers A1 and A2, and data transfer logic that steers the data inputs X1[7:0] or X2[7:0] to the register A1.

Each node of the pipeline graph represented in FIG. 2b, corresponds to one bit of a register in RTL. An arc between a source node, say node A1[0], and a sink node, say B[0], designates that data from register A1 can be transferred to register B in one cycle. A combinatorial logic of the data path, along with the relevant control logic, is attached to the arcs as a logic condition of data transfer or stall.

In the example shown in FIG. 2b, the logic conditions on the (X1[0], A1[0]) and (X2[0], A1[0]) arcs are defined by Boolean function of the RTL node y1, the conditions on the arc (X3[0], A2[0]) are defined by a constant true Boolean function, and the conditions on arcs (A1[0], B[0]) and (A2[0], B[0]) are defined by Boolean function of the RTL node y3 since all data processing elements along with their control (y2) were abstracted away.

Calculation of the exact logic conditions {Cᵢ}, attached to the graph arcs, is a task of the pipeline control analysis step (108 of FIG. 1) of the algorithm. The conditions are calculated by means of symbolic simulation on the full abstract DUT model built on the previous step (104 of FIG. 1). The use of symbolic simulation techniques is well known to those skilled in the art and other types of symbolic simulation may be used without departing from the spirit and scope of the present invention.

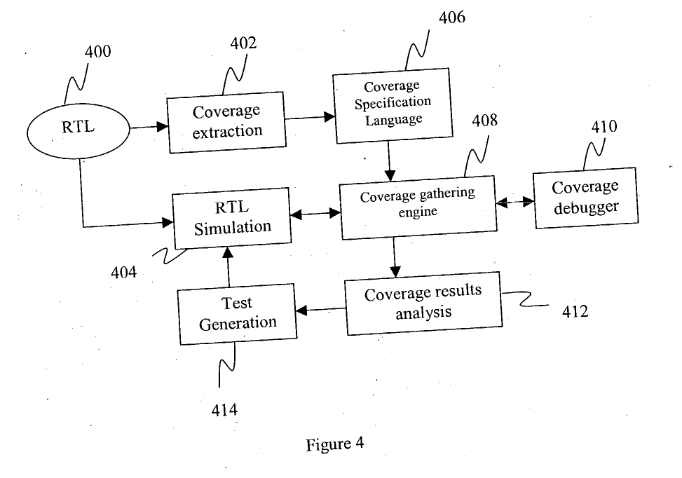

Coverage monitor generation is shown in 108 of FIG. 1 in the PipeCover algorithm. A coverage specification can be compiled into a computer program that runs in a DUT simulation process (see FIG. 4). The specification is based on a set of pipeline specific coverage metrics (e.g. a default metric and a user specified metric).

The following exemplary coverage metrics will be discussed: a One Stage Transfer (OST metric, a Path metric, a One Stage Sequence (OSS) metric, a Microinstruction Flow (MIF) metric, and a Microinstruction Sequence (MIS) metric. Those skilled in the art will appreciate that other metrics may be used with the claimed embodiments.

One aspect of the OST metric is that when pipeline performance for each register is examined, conditions exist to transfer calculated data without stall. The duality of the OST metric requires the test suite to cover local stalls as well.

Let Aᵢ be an input arc of a node A in the pipeline graph. Let Aₒ be an output arc of the node A. Let C(Aᵢ) and C(Aₒ) be Boolean functions associated with these arcs in the pipeline graph. The OST metric for a pair (Aᵢ, Aₒ) is defined as a cross-product of the “on-set” of C(Ai) and the “on-set” of C(Aₒ) with associated timing relation that an input point of C(Aₒ) is observed a cycle after an input point of C(Aᵢ) was observed. The OST metric for the full pipeline graph is defined as a collection of OST metrics for its arcs. The “on-set” of a Boolean function is defined as a set of its input vectors that evaluate the function to be true.

The immediately preceding description may be illustrated by reference to FIG. 2. Suppose the Boolean function of the DUT node y1 depends on the control variables {a, b, c} and the node y3 depends on the control variables {b, d}. Suppose the “on-set” for y1 is {101, 011} and the “on-set” for y3 is {00, 11}. Then the OST metric, defined on a pair of arcs (X1[0]-A1[0], A1[0]-B[0]), is represented by the following result of Cartesian product: (101,00[1]), (011,00[1]), (101,11[1]), (011,11[1]), where [1] denotes that the second condition in each pair is observed a cycle after the first condition is observed.

The Path metric is an extension of the OST metric. It is constructed as a cross-product of the “on-set” of the open conditions along a given path. Each subsequent condition in the path is observed a cycle after its successor condition was observed. A modification of the Path metric is also proposed, which is a cross-product of the close conditions along a given path at the same time point. This metric may be used to cover stalled paths in the pipeline.

The idea of the OSS metric is to cover basic stall-transfer interactions. As in the case of the OST metric, the coverage space of OSS is defined for all pipeline graph nodes over all pairs of input-output arcs of a node. If C(Ai) and C(Aₒ) are Boolean functions associated with an arc pair in the graph, a set S can be constructed that contains all four combinations when these functions equal true and false. Then the OSS metric is a cross-product S*S over one cycle time window.

In particular configurations on the pipeline graph, some combinations of events must be excluded. For example we must exclude (forbid) combinations that describe local hazards in the pipeline. For example, if node A has unique successor B in the graph, then combination (C(Aᵢ) AND NOT C(Aₒ), (C(Aᵢ) AND NOT C(Aₒ))[1]) states that data in A is overwritten before it is read, and combination (NOT C(Aᵢ) AND C(Aₒ), (NOT C(Aᵢ) AND C(Aₒ))[1]) states that B is updated by the old value, before the new value is written in A. Directed by a request from the user, PipeCover may generate temporal assertions to check these combinations during simulation runs.

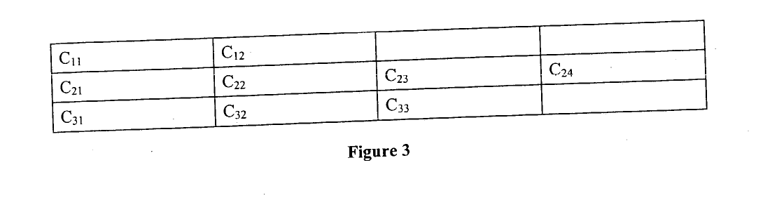

FIG. 3 provides an example illustrating how the Micro Instruction Flow is defined. The MIF coverage metric is defined on a set of paths in the pipeline graph that covered in parallel. The idea of the metric is to utilize the user knowledge about the legal scenarios of the data transfer via the pipeline. If, for example, the user has defined a set of paths that is shown on FIG. 3 by means of Boolean conditions associated with paths arcs in the pipeline graph, then the MIF goal is defined as a Cartesian product of “on-sets” S₁, S₂[1l], S₃[1], S₄[1] where a set Sⱼ is built for the Boolean function (C₁ⱼ and C₂ⱼ and C₃ⱼ and C₄ⱼ). If a path i does not have arc j, the constant true function is taken for Cᵢⱼ. There may be cases when a Boolean function (C₁ⱼ and C₂ⱼ and C₃ⱼ and C₄ⱼ) is equal to a constant false function. Two reasons exist for that: 1) the user has defined a set of paths that could not be covered in parallel; and 2) there is a bug in the DUT, but it has been detected without simulation. The MIS metric is defined on top of the MIF metric as a set of different sequences of MIF.

All coverage metrics can be created based on the full or pruned pipeline graph. Pruning a pipeline graph is a process of building a sub-graph by deleting nodes and arcs from the graph or by incrementally expanding the sub-graph starting from some set of the graph nodes. The PipeCover tool incorporates a graphical user interface to facilitate the process of pruning.

FIG. 4 illustrates an exemplary method and application of a PipeCover in a Functional Coverage Validation System, where a coverage specification can be compiled into a computer program that runs in a DUT simulation process. A starting point of the exemplary Functional Coverage Validation System is an RTL model 400 of a design under test (DUT). The output of the RTL model 400 is then forwarded to the PipeCover tool 402 and to the RTL simulation 404. In 406, an input (e.g. coverage and extraction information) is received from the PipeCover tool 402 and coverage related to the specification language is determined. In 408, a coverage gathering engine receives an input from 406 and a bi-directional information flow is established with the coverage debugger 410 and the RTL simulation 404. Coverage results analysis 412 is obtained from the coverage gathering engine 408. A test generation function 414 obtains an input from the coverage results analysis 412 and then forwards the results of the test generation 414 to the RTL simulation 404.

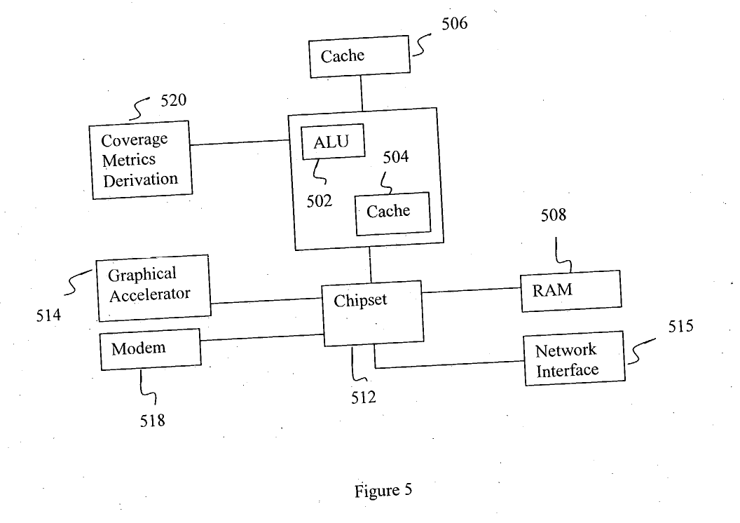

FIG. 5 illustrates an exemplary global illustration of a computer incorporating a system for automatically deriving coverage metrics for validation of pipelined designs. The computer system may include a microprocessor 500, which includes many sub-blocks, such as an arithmetic logic unit (ALU) 502 and an on-die cache 504. Microprocessor 500 may also communicate to other levels of cache, such as off-die cache 506. Higher memory hierarchy levels such as system memory 508 (e.g. RAM), are accessed via a host bus 510 and chipset 512. In addition, other off-die functional units, such as a graphics accelerator 514, a network interface 516 and a modem 518, to name just a few, may communicate with the microprocessor 500 via appropriate busses, ports or other communication devices.

In FIG. 5, a coverage metric derivation system 520 is connected to the microprocessor. Note that the coverage metric system is exemplary in nature and may be interfaced or coupled with the computer system in various different configurations and locations without departing from the spirit and scope of the embodiments of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for deriving coverage metrics comprising:
building a hardware model of a design under test;
identifying a circuit structure by using an abstraction process; and
calculating at least one logic condition for a predetermined circuit structure.

2. The method of claim 1, wherein the circuit structure identified is a pipeline structure.

3. The method of claim 1, wherein the result is a pipeline graph and the pipeline graph represents connections of a pipeline to an interface.

4. The method of claim 3, wherein the interface is a user.

5. The method of claim 3, wherein the interface is a processor.

6. The method of claim 3, wherein the interface is a processing device.

7. The method of claim 3, wherein graph pruning is applied to the pipeline graph.

8. The method of claim 3, wherein the pipeline graph is used to define user-specific coverage metrics

9. The method of claim 1, wherein metrics are used to automatically generate coverage monitors.

10. The method of claim 1, wherein the metrics are user-specific coverage metrics and the user-specific coverage metrics are used to automatically generate coverage monitors.

11. The method of claim 1, wherein a hardware model is constructed by a hardware inference process.

12. The method of claim 11, wherein the hardware inference process comprises a logic synthesis operation.

13. The method of claim 12, wherein the logic synthesis operation comprises fast logic synthesis.

14. The method of claim 13, wherein the fast logic synthesis does not require logic optimization.

15. The method of claim 2, wherein for each stage of an identified pipeline structure, logic conditions are based upon a data transfer state.

16. The method of claim 2, wherein for each stage of an identified pipeline structure, logic conditions are calculated when the pipeline registers are open for a particular data source.

17. The method of claim 2, wherein for each stage of an identified pipeline structure, logic conditions are calculated when the pipeline registers are closed for a particular data source.

18. The method of claim 1, wherein an abstraction process operation is performed.

19. The method of claim 1, wherein the abstraction process operation is accomplished by separating the data path and control flow and abstracting away unneeded logic.

20. A method for deriving coverage metrics comprising:
inputting a Register Transfer Level (RTL) into a hardware model;
performing a pipeline extraction and abstraction and accounting for user's directives;
controlling and analyzing a pipeline structure; and
generating at least one coverage monitor to establish at least one coverage metric.

21. The method of claim 20, wherein the at least one coverage metric targets at least one data transfer feature of a pipeline design.

22. The method of claim 20, wherein the at least one coverage metric is used to verify hardware in a simulation-based, coverage-driven validation flow.

23. The method of claim 20, wherein at least one of the coverage metrics is a one stage transfer (OST) metric.

24. The method of claim 20, wherein at least one of the coverage metrics is a path metric.

25. The method of claim 20, wherein at least one of the coverage metrics is a one stage sequence (OSS) metric.

26. The method of claim 20, wherein at least one of the coverage metrics is a microinstruction flow (MIF) metric.

27. A system for deriving coverage metrics comprising:
an input device inputting a Register Transfer Level (RTL) into a hardware model;
a processor performing a pipeline extraction and abstraction and accounting for user's directives;
a controller controlling and analyzing a pipeline structure; and
a generator generating at least one coverage monitor to establish at least one coverage metric.

28. The system of claim 27, further comprising:
determining a pipeline graph to represent connections of a pipeline to an interface.
